(19) United States
(12) Patent Application Publication
(10) Pub. No.: US 2004/0055483 A1
(43) Pub. Date: Mar. 25, 2004

(54) Afterglowing sign

(76) Inventor: Sven Thollin, Stanffanstorp (SE)

Correspondence Address: BURNS DOANE SWECKER & MATHIS L L P, POST OFFICE BOX 1404, ALEXANDRIA, VA, 22313-1404, US

(21) Appl. No.: 10/467,299

(22) PCT Filed: Feb. 20, 2002
(86) PCT No.: PCT/SE02/00290

(30) Foreign Application Priority Data
Feb. 23, 2001 (SE) 00100615-4

(51) Int. Cl. B41F 17/00

(52) U.S. Cl. 101/35

(57) ABSTRACT

The present invention relates to an afterglowing sign printed with afterglowing pigments. The sign is provided at least partially with a screen print using opaque or transparent ink.

### FIELD OF THE INVENTION

The present invention relates to an afterglowing sign printed with afterglowing pigments.

### BACKGROUND ART

In the case of danger, alarm, fire, smoke formation, threats, etc., the presence of clearly visible signs in premises is extremely important, for example for indicating the nearest escape route or the location of fire extinguishing equipment. According to the colour requirements stipulated by the appropriate authority, the signs shall have one or more white, standardised symbols on red or green ground.

Some of the existing afterglowing safety signs are used, inter alia, to indicate and display escape routes and emergency exits and to indicate the location of fire extinguishing equipment. However, the afterglowing pigments used do not exist in the colour shades needed to obtain an optimal colour reproduction both in daylight and, with a coloured afterglow, in the dark. The solution to this problem has so far been to accept that these signs show afterglowing symbols only in the dark, in which case their ground colour has been perceived as black. Thus, the colour requirements for these afterglowing safety signs are met only in daylight and in lit places, since the afterglowing pigments available do not completely fulfil the requirements both in daylight/lit spaces and in the dark.

### SUMMARY OF THE INVENTION

It is therefore an object of the present invention to provide an afterglowing sign which affords an optimal colour reproduction both in daylight and, with a coloured afterglow, in the dark. This object is achieved by the afterglowing sign, which is printed with afterglowing pigments, being provided at least partially with a screen printing using opaque or transparent ink.

In a preferred embodiment of the present invention, a contour recess is provided in the afterglowing ground surface along the contour of symbols printed on the sign in order to increase the contrast between the symbols and the background in the dark.

In a further preferred embodiment, the afterglowing pigments are white/yellowish-white, red and/or green.

In yet another embodiment, the screen printing is a line screen or a dot screen.

In one embodiment, the afterglowing pigments are printed as whole surfaces, in the form of screens, or incorporated into the material of the sign.

In one embodiment, the sign is made of metal, plastic or composite and, in another embodiment, it is made of a transparent or translucent material.

### BRIEF DESCRIPTION OF THE DRAWINGS

The invention will be described in more detail in the following by means of one preferred embodiment and with reference to the accompanying drawings, in which FIG. 1 is a view of a sign according to the invention, a line screen being used when adding the supplementary opaque or, alternatively, transparent ink;

FIG. 2 is a view of a sign according to the invention, a dot screen being used when adding the supplementary opaque or, alternatively, transparent ink; and

FIG. 3 is a schematic view of a sign according to the invention, in which a contour recess is formed in the afterglowing ground surface along the contour of the symbols.

### DESCRIPTION OF A PREFERRED EMBODIMENT

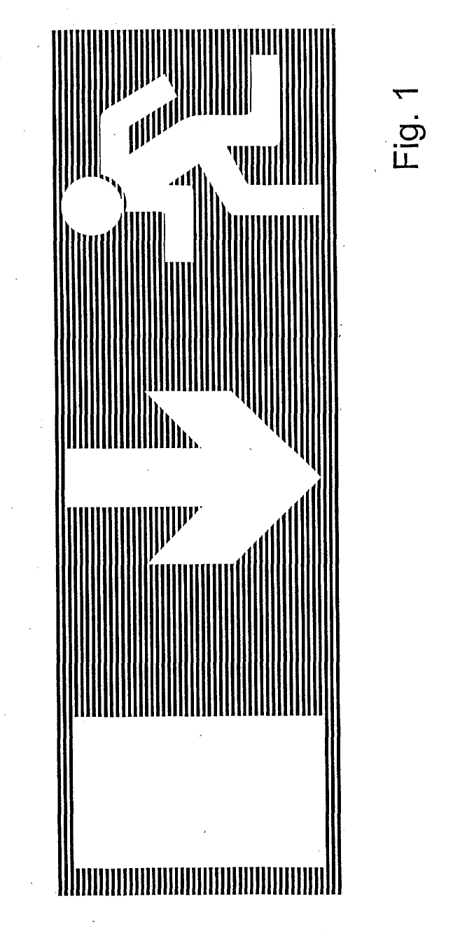

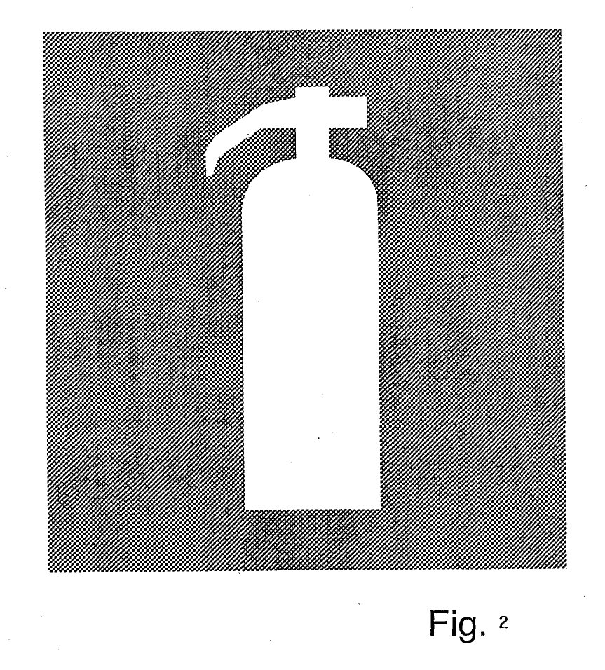

FIG. 1 and FIG. 2 illustrate two preferred signs according to the present invention. FIG. 1 shows an escape route sign, which, according to standard, has a green background and white symbols and border rule. FIG. 2 shows a sign for indicating the location of fire extinguishing equipment, which, according to standard, has a red background and a white symbol and border rule.

The signs are made of aluminium or plastic and are silk screen printed. Any type of afterglowing pigments may be used;.preferred but non-limiting pigments are Mo.Al₂O₃ doped with Eu as white/yellowish-white afterglowing pigment, (CaO,8 SrO,2)S—CaS as red afterglowing pigment, and Mo.Al₂O₃ doped with Eu plus fluorescent green pigment as green afterglowing pigment.

The choice of afterglowing pigment or afterglowing ink is not decisive. Thus, the technical effect is not dependent on the pigment or the ink used to obtain the afterglowing print, if the sign is provided with a screen of opaque or transparent ink.

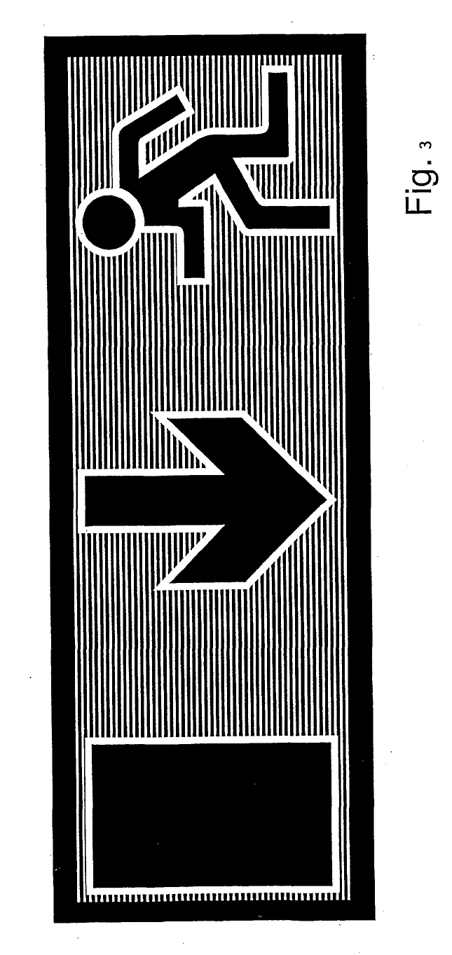

First, the afterglowing pigments are printed on the sign either as whole surfaces or as a screen print. A contour recess along the contour of the symbols and the border rule, with a width of about 1.5-3 mm, may also be made (see FIG. 3) when printing the afterglowing ground surface in order to increase the contrast between the background and the symbols/border rule in the dark.

The surfaces printed with respectively red and green afterglowing pigments, i.e. the background, are supplemented by a line screen (FIG. 1) or, alternatively, a dot screen (FIG. 2) of opaque or transparent ink. Preferably, the screen is printed with respectively red and green opaque ink to supplement the red or green afterglowing background.

It will be appreciated that modifications of the preferred embodiments described above are possible within the scope of the invention, as defined by the appended claims. For example, the afterglowing sign does not have to be an escape route sign or a sign indicating the location of fire extinguishing equipment, but may be of some other type, for instance a sign used for advertising purposes.

1. An afterglowing sign printed with afterglowing pigments, characterised in that the sign is provided at least partially with a screen print using opaque or transparent ink.

2. An afterglowing sign according to claim 1, wherein a contour recess is formed in the afterglowing ground surface along the contour of symbols printed on the sign.

3. An afterglowing sign according to claim 1 or 2, wherein the afterglowing pigments are white/yellowish-white, red and/or green.

4. An afterglowing sign according to any one of claims 1-3, wherein the screen printing is of line screen or dot screen type.

5. An afterglowing sign according to any one of claims 1-4, wherein the afterglowing pigments are printed as whole surfaces, in the form of screens, or are incorporated into the material of the sign.

6. An afterglowing sign according to any one of claims 1-5, wherein the sign is made of metal, plastic or composite.

7. An afterglowing sign according to any one of claims 1-5, wherein the sign is made of a transparent or translucent material.
